(19) United States
(12) Patent Application Publication
(10) Pub. No.: US 2022/0393498 A1
(43) Pub. Date: Dec. 8, 2022

(54) PORTABLE WIRELESS CHARGING APPARATUS AND SYSTEM

(71) Applicant: Shou Qiang ZHU, Ontario, CA (US)

(72) Inventor: Shou Qiang ZHU, Ontario, CA (US)

(73) Assignee: MAXTON ENGINEERING LTD., Hong Kong (CN)

(21) Appl. No.: 17/341,759

(22) Filed: Jun. 8, 2021

(51) Int. Cl. H02J 7/02; H02J 50/10; H02J 7/00

(52) U.S. Cl. CPC H02J 7/02; H02J 50/10; H02J 7/0048; H02J 7/0044

(57) ABSTRACT

A portable wireless charging system may include a charging case and at least one power bank received in the case. The charging unit can be charged when it is received in the case through an external charging cable. In one embodiment, the power bank can be taken out to attached to a back portion of a mobile device to charge the device. In another embodiment, the mobile device can be charged when being disposed on a front or back surface of the charging case when the charging unit is inside the case.

### FIELD OF THE INVENTION

The present invention generally relates to a wireless power charging system, and more particularly to a portable device or system to provide both regular cable charging and wireless charging to mobile electronic devices.

### BACKGROUND OF THE INVENTION

Mobile phones are used for a variety of purposes, including keeping in touch with family members, conducting business, and having access to a telephone in the event of an emergency. Some people carry more than one cell phone for different purposes, such as for business and personal use. More recently, smartphones emerged to quickly replace traditional mobile phones. Simply speaking, smartphones are mobile phones equipped with more advanced computing capability and connectivity to perform much more tasks than basic mobile phones. More particularly, smartphones typically combine the features of a mobile phone with some other popular consumer devices, such as a personal digital assistant (PDA), a media player, a digital camera, or a GPS navigation unit. Modern smartphones may include more features including a touchscreen computer, a web browser and a plurality of application software (“Apps”).

One of the most important concerns of smartphone users is the battery life. As stated above, modern smartphones can perform just like a mini computer, however, unlike computers that may be used with the power cords for most of the time, smartphone users usually carry the phones with them and the battery inside the phone may be a sole power source thereof. Therefore, it may be inconvenient for the users if the battery cannot last long enough and the smartphone may lose the portability if the user has to charge it often.

To solve the battery issues in smartphones and other mobile devices such as tablets, currently people take power banks with them to prevent the mobile devices from running out of battery. A USB cable is usually needed to charge the mobile device, so if the user forgets to bring the USB cable with him/her, the mobile device cannot be charged. Although some manufactures make power banks with USB cables irremovable therefrom, the aesthetics value of the power bank may be sacrificed, as well as the integrity and rigidness thereof.

There are also smartphones having internal components, so the phones can be charged wirelessly, literally without connecting to the charging dock through cables. However, all wireless power banks need to be plugged to the regular 110V power supply on the wall, and people still cannot wirelessly charge their mobile device(s) wherever and whenever they need to. The wireless power bank that still needs to be plugged to the power supply on the wall is not considered “portable” because people cannot use it on the go.

U.S. Pat. No. 8,432,129 to Lee et al. (hereinafter “Lee”) disclosing a wireless charging system can optimize charging efficiency regardless of a location of a mobile terminal. More specifically, the wireless charging system wirelessly charges a mobile terminal using electromagnetic induction between a first coil included in a charging pad and a second coil included in the mobile terminal. The charging pad can detect a location of the mobile terminal on the charging pad. The charging pad can move the first coil to correspond to the detected location of the mobile terminal; and supply power to the first coil and charging a battery. However, the power source of the wireless charging system, as shown in FIG. 1, is still from a power cord plugging to the wall, which may still be inconvenient for the user when the socket is not available. Therefore, there remains a need for a new and improved portable wireless power bank to overcome the problems stated above.

### SUMMARY OF THE INVENTION

It is an object of the present invention to provide a portable power bank to wirelessly charge mobile devices and the portable power bank does not need to connect to the power source on the wall while charging the mobile device.

It is another object of the present invention to provide a portable power bank to wirelessly and more efficiently charge the mobile devices than traditional wired chargers.

It is a further object of the present invention to provide a portable power bank that can simultaneously charge more than one mobile devices.

Typical wireless charging system applies power to a charging apparatus including a coil therein, and charges a battery using an induced current generating in a receiver included in a mobile terminal, or a battery using a magnetic field generating in the coil in the charging apparatus. A portable power bank that is used to wirelessly charge a mobile device may include a wireless charging surface, a main case, a battery level indicator, a power control button and a charging electrode.

When in use, the user can simply dispose a mobile device, such as a cell phone with a contacting member onto the wireless charging surface, the cell phone can be charged within a few seconds. It is noted that the portable power bank is not connected or plugged into any power supply on the wall when charging the cell phone. In one embodiment, the contacting member can be a magnet to engage with a corresponding groove on the charging surface.

In another embodiment, the portable power bank can be charged in a charging case, which may include a power indicator for each power bank, a charging slot for each power bank, a power indicator for the charging case, a power control, and a power charging port. The charging case is configured to charge the power bank(s) when the power charging port is plugged to a power source. The size of the charging case is relatively small so it is easy for the user to carry and transport.

It is worth to note that the mobile device can also be charged when being disposed on an outer surface of the charging case. More specifically, when the power bank is being charged inside the charging case, the mobile device can still be charged by the power bank inside the charging chase through electromagnetic induction.

In a further embodiment, the mobile device can be charged on a stand. The stand may include a base, a connecting unit, and a power bank holder. The power bank holder is connected with the connecting unit that is integrated with the base. In one embodiment, the power bank holder and the connecting unit can be connected through magnetic force. The power bank can be disposed on the power bank holder and then charge the mobile device as stated above. It is noted that the power bank holder may include a charging electrode that can be used to charge the power bank when the stand is connected to a power source.

In still a further embodiment, the mobile device can be charged in a vehicle through a car charge system. The car charging system may include a power bank holder, a connecting unit and a charging cable. In one embodiment, the power bank holder and one end of the connecting unit can be connected through magnetic force, and the other end of the connecting unit can be secured in the vehicle. The power bank can be disposed on the power bank holder and then charge the mobile device as stated above. It is noted that the power bank holder that can be used to charge the power bank when the charging cable is connected to a power source in the car.

### BRIEF DESCRIPTION OF THE DRAWINGS

FIG. 1 is a schematic view of the power bank attaching to the mobile device to charge the mobile device in the present invention.

FIG. 2 illustrates a schematic view of the power bank detaching the mobile device in the present invention.

FIG. 3 illustrates a schematic view of the power bank in the charging case in the present invention.

FIG. 4 illustrates a schematic view of the mobile device charged on a stand with the power bank in the present invention.

FIG. 5 illustrates a schematic view of the mobile device charged on a car charging system with the power bank in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

Typical wireless charging system applies power to a charging apparatus including a coil therein, and charges a battery using an induced current generating in a receiver included in a mobile terminal, or a battery using a magnetic field generating in the coil in the charging apparatus. In one embodiment, a power bank in the present invention may include a battery; a coil configured to detect whether a receiver of a first mobile device is nearby and to emit electrical magnetic pulses to realize the wireless charging; a wireless charging modulator configured to take direct current from the battery, transform the direct current into alternate current pulses and send the alternate current pulses to the coil; and a power control circuit to manage usage of the battery.

The power control circuit has a power managing unit and a detecting unit, said power managing unit configured to raise a battery level of the battery to a predetermined charging level, and said detecting unit continuously monitoring battery levels of the battery and a first battery in the first mobile device respectively to determine whether to terminate the wireless charging of the first mobile device.

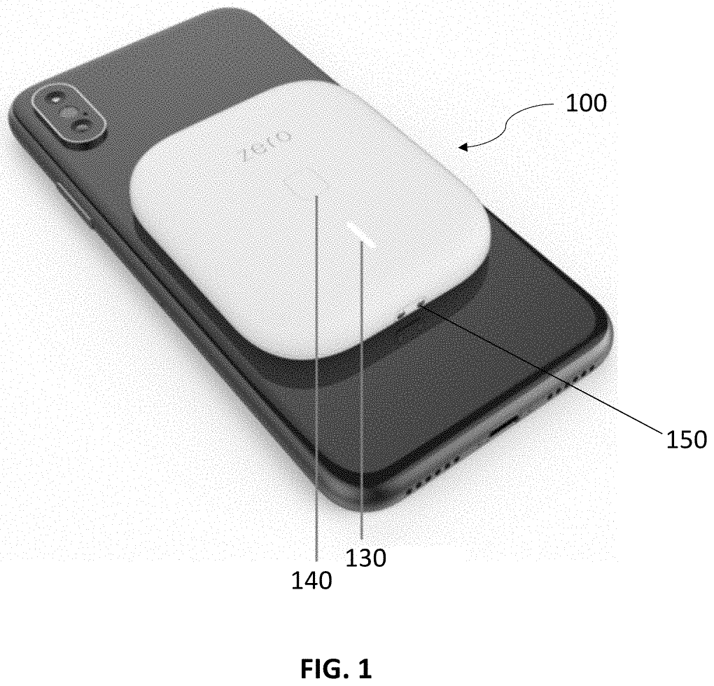

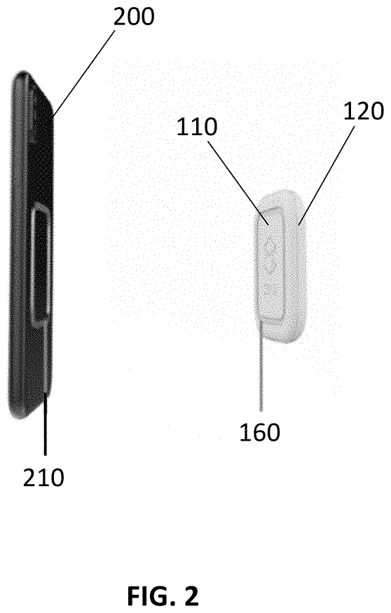

Referring to FIGS. 1 and 2, the portable power bank 100 that is used to wirelessly charge a mobile device may include a wireless charging surface 110; a main case 120, a battery level indicator 130, a power control button 140 and a charging electrode 150.

When in use, the user can simply dispose a mobile device, such as a cell phone 200 with a contacting member 210 onto the wireless charging surface 110, the cell phone 200 can be charged within a few seconds. It is noted that the portable power bank 100 is not connected or plugged into any power supply on the wall when charging the cell phone 200. In one embodiment, the contacting member 210 can be a magnet to engage with a corresponding groove 160 on the charging surface 110.

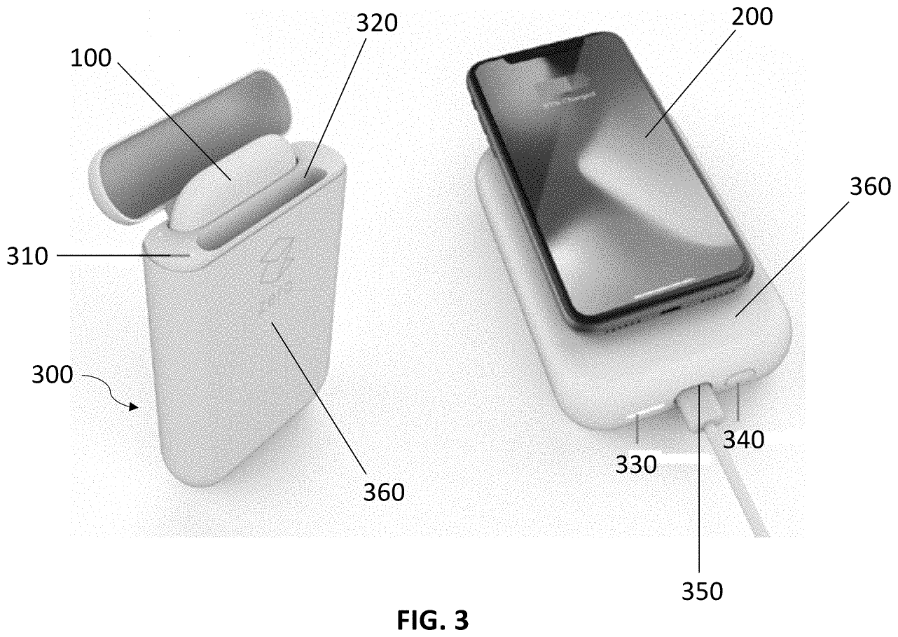

In another embodiment, referring to FIG. 3, the portable power bank 100 can be charged in a charging case 300, which may include a power indicator 310 for each power bank 100, a charging slot 320 for each power bank 100, a power indicator 330 for the charging case, a power control 340, and a power charging port 350. The charging case 300 is configured to charge the power bank(s) 100 when the power charging port 350 is plugged to a power source. The size of the charging case 300 is relatively small so it is easy for the user to carry and transport.

It is worth to note that the mobile device 200 can also be charged when being disposed on an outer surface of the charging case 300. More specifically, when at least one power bank 100 is being charged inside the charging case 300, the mobile device 200 can still be charged by the power bank 100 inside the charging chase 300 through electromagnetic induction as shown in FIG. 3.

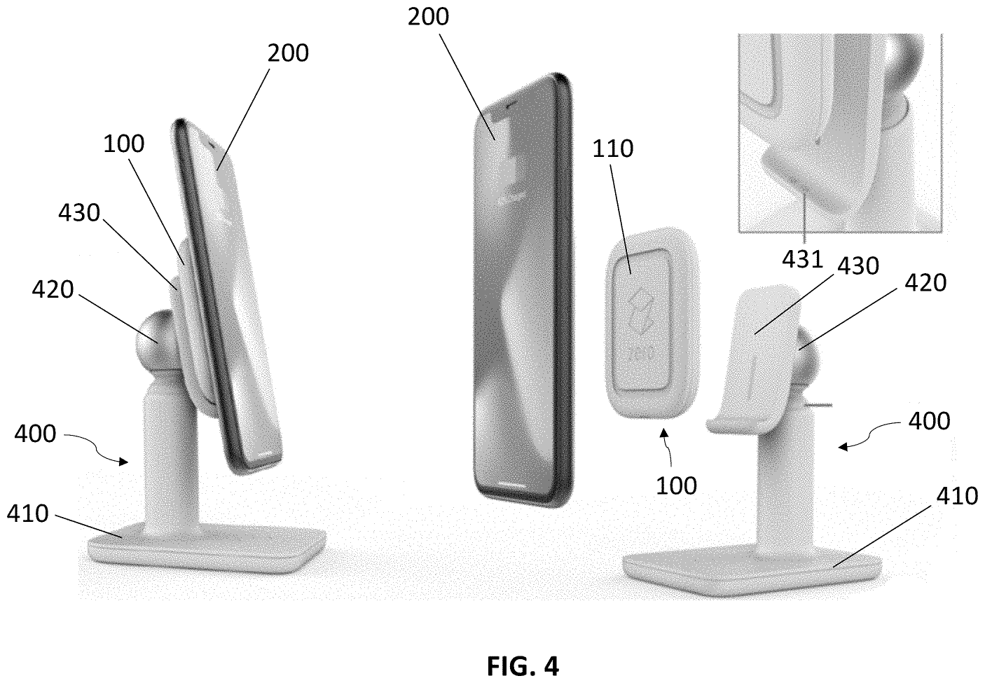

In a further embodiment, the mobile device 200 can be charged on a stand 400. The stand 400 may include a base 410, a connecting unit 420, and a power bank holder 430. The power bank holder 430 is connected with the connecting unit 420 that is integrated with the base 410. In one embodiment, the power bank holder 430 and the connecting unit 420 can be connected through magnetic force. As shown in FIG. 4, the power bank 100 can be disposed on the power bank holder 430 and then charge the mobile device 200 as stated above. It is noted that the power bank holder 430 may include a charging electrode 431 that can be used to charge the power bank 100 when the stand 400 is connected to a power source.

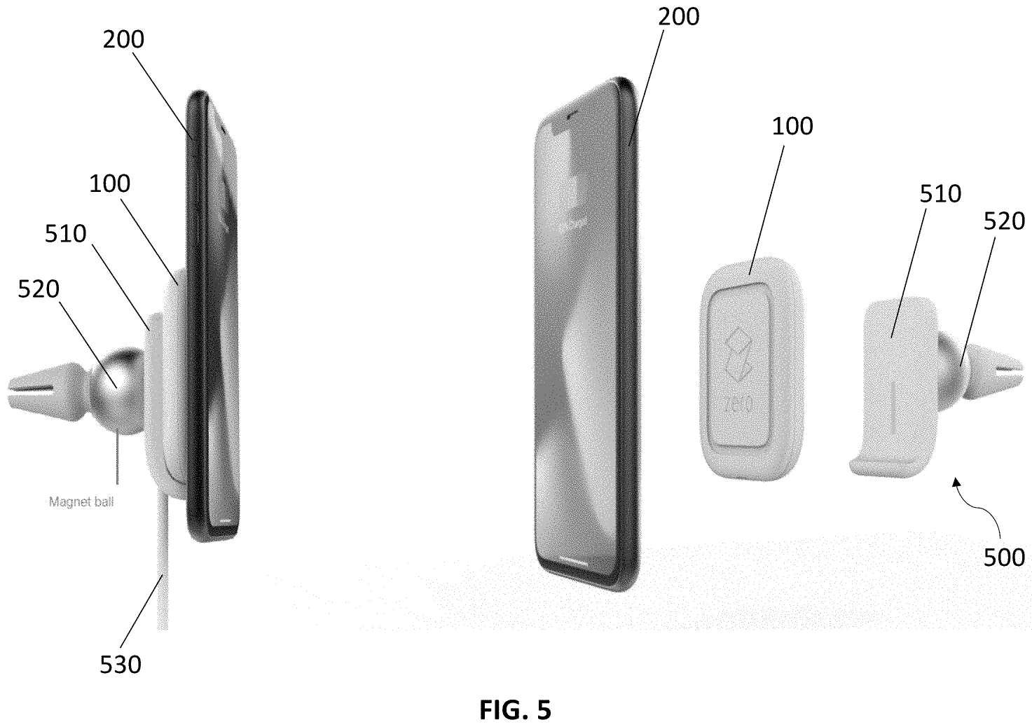

In still a further embodiment, the mobile device 200 can be charged in a vehicle through a car charge system 500. The car charging system 500 may include a power bank holder 510, a connecting unit 520 and a charging cable 530. In one embodiment, the power bank holder 510 and one end of the connecting unit 520 can be connected through magnetic force, and the other end of the connecting unit 520 can be secured in the vehicle. As shown in FIG. 5, the power bank 100 can be disposed on the power bank holder 510 and then charge the mobile device 200 as stated above. It is noted that the power bank holder 510 that can be used to charge the power bank 100 when the charging cable 530 is connected to a power source in the car.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A portable wireless charging apparatus comprising:
a battery;
a coil configured to detect whether a receiver of a first mobile device is nearby and to emit electrical magnetic pulses to realize the wireless charging;
a wireless charging modulator configured to take direct current from the battery, transform the direct current into alternate current pulses and send the alternate current pulses to the coil; and
a power control circuit to manage usage of the battery,
wherein the power control circuit has a power managing unit and a detecting unit, said power managing unit configured to raise a battery level of the battery to a predetermined charging level, and said detecting unit continuously monitoring battery levels of the battery and a first battery in the first mobile device respectively to determine whether to terminate the wireless charging of the first mobile device.

2. The portable wireless charging apparatus of claim 1, wherein a charging case that has one or more the charging slots to receive and charge the portable wireless charging apparatus.

3. The portable wireless charging apparatus of claim 2, wherein the first mobile device can be charged on an outer surface of the charging case when at least one power bank is in the charging case.
